(19) United States
(12) Patent Application Publication
(10) Pub. No.: US 2008/0105350 A1
(43) Pub. Date: May 8, 2008

(54) Air no air elastomeric tire

(76) Inventor: Richard A. Steinke, Boulder City, NV (US)

Correspondence Address: M. REID RUSSELL, 854 WEST 3390 SOUTH, HURRICANE, UT, 84737, US

(21) Appl. No.: 11/975,623

(22) Filed: Oct. 22, 2007

Related U.S. Application Data
(63) Continuation of application No. 11/203,542, filed on Aug. 12, 2005, now abandoned.
Application No. 11/203,542 is a continuation-in-part of application No. 09/665,604, filed on Sep. 20, 2000, now abandoned.
Application No. 11/203,542 is a continuation-in-part of application No. 09/943,814, filed on Sep. 4, 2001, now abandoned.
Application No. 11/203,542 is a continuation-in-part of application No. 10/412,471, filed on Apr. 9, 2003, now abandoned.

(51) Int. Cl. B60C 3/00

(52) U.S. Cl. 152/454

(57) ABSTRACT

An elastomeric tire for mounting onto a rim that is manufactured by casting or molding methods to include an exterior arch shaped cavity that is centered under and is below the tire tread to have at least one hundred forty (140) degrees and not more than one hundred seventy (170) degrees of arc from one tire rim mounting contact point, around the tire to another tire rim mounting contact point, and with the cavity arch duplicated around the tire interior. A uniform tire wall thickness is provided that is selected for a particular anticipated load as the tire will carry, with the tire side wall ends each maintained at one the rim opposing ends, supporting the load carried by the tire in compression, and with the tire, at atmospheric pressure, providing ride and wear characteristics that are comparable to a pressurized pneumatic tire carrying a like load, and which tire of the invention interior arch-shaped cavity can be pressurized to add to its inherent load supporting character to safely support even greater loads.

This application is a continuation application of a third continuation-in-part application that derived from an application Ser. No. 09/665,604 for an “AIR NO AIR ELASTOMERIC TIRE” filed Sep. 20, 2000, a continuation-in-part application Ser. No. 09/943,814 for an “AIR NO AIR ELASTOMERIC TIRE” filed Sep. 4, 2001, a continuation-in-part application Ser. No. 10/412,471 for an “AIR NO AIR ELASTOMERIC TIRE” and a third continuation in part application Ser. No. 11/203,542, filed Aug. 12, 2005, for an “AIR NO AIR ELASTOMERIC TIRE” that is abandoned with the entry of this continuation application.

### BACKGROUND OF INVENTION

1. Field of the Invention

This invention pertains to non-pneumatic tires for mounting onto a rim as a component of a wheel, and particularly to a tire that is formed, preferably by molding methods, from an elastomeric material, having a center cavity whose walls are capable of bearing a load, allowing the tire to safely support a design load with only air at ambient pressure therein, and the center cavity of which tire can be aired to a desired pressure to support a greater load.

2. Prior Art

The present invention contemplates a new and improved tire that, while simple in design, is revolutionary in its concept, constituting a major improvement in the tire industry. The tire of the invention will exhibit the ride and wear characteristics of, or are better than that of, a conventional pneumatic tire, that is intended for a like use to the tire of the invention. Which tire of the invention has, by its construction and wall thickness selection, an inherent load bearing capability that is essentially equivalent to the load bearing capability of a like size of pneumatic tire. So arranged, even without air, the tire of the invention will still provide load bearing support to a vehicle on which it is mounted. Further, the tire can additionally be aired to a desired greater pressure for supporting a greater load.

Elastomeric, solid, cavity free, non-pneumatic tires have been used for many years going back to as early as 1878, as set out in a British Patent No. 2,367, that shows a solid rubber tire and rim. Even where such rubber tires have been formed to include inner cavities, as illustrated in U.S. Pat. Nos. 450,816 and 464,767 such have not considered the load-bearing function of a uniform tire relationship of wall thickness between the tire inner wall and outer wall under the tread, as does the invention, for carrying different loads. Further the arcs of the wheels of the U.S. Pat. No. 464,767 outer surfaces are shown as formed to have a greater than one hundred seventy degrees of arch, as called for in the invention. While solid rubber tires having cavities are also shown in U.S. Pat. Nos. 612,583; 684,157; and 1,670,446, the cavities of these patents are circles or modified circles and they do not include any recitation in any of the embodiments of a relationship of the cavity and tire outer surface that is supported by rim edges at ends of one hundred seventy degrees or arc or less, for providing columnar support to a load applied to the tire tread area, as called for by the invention. Further, while a U.S. Pat. No. 1,014,318 shows, in FIG. 1, a tire having an arch shaped cavity, with the tire side wall ends maintained between hook ends of a rim, the patent is directed to rim configurations only and there is no discussion of a relationship between load bearing capabilities as relates to wall thickness between the inner and outer arch surfaces. Finally, while cavities are shown in the wheels of U.S. Pat. Nos. 3,948,30; 5,524,913; 5,988,764; 6,145,937; 6,186,598, and 6,318,428, these patents are directed to tire mountings to a rim. Or, as in U.S. Pat. No. 2,779,380, to a tubeless tire. In U.S. Pat. No. 3,329,192 a cross bar tire mounting is shown and, in U.S. Pat. No. 6,279,631, a low pressure tire is shown, and there is no discussion of loading bearing capabilities of the tire and wheel arrangements. Only the present invention recognizes the load bearing capabilities of an elastomeric tire having a centered arch shaped cavity and like outside surface of no greater than one hundred seventy degrees of arc between rim support ends and uniform wall thickness and relates load bearing capability of a tire at atmospheric or ambient pressure to wall thickness between the arch shaped cavity surface and the tire outer surface, below the tread.

Where a number of later patents also show non-pneumatic tire and tire and rim combinations including, for example: British Patents No.'s 3,432; 20,186; and 27,224, French Patents No.'s 338,920 and 367,981 and U.S. Pat. Nos. 1,056,976; 1,178,887; 3,533,662 and 5,229,047, these patents, do not show an arch shaped inner cavity. Further, non-pneumatic tires that do not include a center cavity are shown in earlier U.S. Pat. Nos. 4,855,096; 4,943,323, 5,906,836 and 6,165,397 that were co-invented by the present inventor. Additionally, other earlier patents covering non-pneumatic tires that include inner cavities that are not arch shaped, are shown in early British Patent No.'s 11,800 and 14,997; along with early U.S. Pat. Nos. 1,194,177 and 1,670,721. While such cavities are set out as for allowing compressions of the tire side walls and bead sections so as to allow the tire to be fitted into a rim, and for cushioning, and where such cavities have provided load-bearing capabilities, like those shown in early U.S. Pat. Nos. 1,004,480 and 1,004,481, such have not been cast tires like that of the invention. None of which solid non-pneumatic tires, have included an arch shaped cavity having a load-bearing capability as governed by wall thickness like that of the invention, where the tire side wall is of uniform thickness, under the tread. While, of course, a tire has had a uniform wall thickness, as, for example, as shown in U.S. Pat. Nos. 1,707,014; 1,940,077 and 3,888,291, such side walls are not load bearing when the tire is depressurized to approximately atmospheric pressure.

It is, of course, well known that non-pneumatic tires, such as those shown in some of the above cited prior art patents, have the advantage of not going flat. Heretofore, however, this advantage has not outweighed the better cushioning and shock absorbing characteristics presented by a pneumatic tire as well as the fact that solid tires, whether formed from rubber, urethane, or the like, tend to build up heat through hysteresis flexure when supporting a significant load. Pneumatic tires generally have less mass than a comparable non-pneumatic tire and, and with their internal cavity they tend to dissipate heat. The tire of the invention is preferably molded to include a central cavity that, dependent upon the rim configuration, can be air retaining and, accordingly, like the pneumatic tire with its open interior, will not experience a damaging heat build-up during rolling under a significant load.

Unique to the invention, the tire interior cavity is formed as a load-bearing arch of at least one hundred forty (140) and no more than one hundred seventy (170) degrees of arc that provides an inherent load support strength for the wall thickness between the arch shaped cavity wall and the tire outer wall, under the tread. So arranged, the tire of the invention, with the tire arch shaped cavity pressurized to atmospheric pressure only, will exhibit a load-bearing capacity in relation to its wall thickness for supporting a wide range of tire loads. The tire of the invention will not experience a flat, and, additionally, the arch shaped tire cavity of the invention can be pressurized to more than atmospheric pressure to increase its inherent load bearing character.

The arch design of the invention uniformly transfers loads from the tread through the arch and into a rim whereto the tire is mounted. The load as the tire will maintain when the cavity is at ambient air pressure is determined by the width or thickness of the tire between the arch shaped cavity wall and the tire outer surface, under the tread. The greater the load, the thicker the wall thickness needs to be to maintain the load. Except, however, to maintain a greater load with normal or lesser wall thickness, the arch shaped cavity can be aired to a greater than atmospheric pressure. The tire of the invention can, within the scope of this disclosure, can include beads for maintaining it onto a rim, and can include side wall plies and tread reinforcement with a belt or belts that can be installed in the tire during the manufacturing process.

### SUMMARY OF THE INVENTION

It is a principal object of the present invention to provide an elastomeric tire formed by molding methods to include an internal arch shaped cavity where the cavity arch is centered under the tire tread to provide structural support to safely transfer loads from the tire tread through the side walls and into the rim, supporting the tire under load, and which cavity can receive air under pressure for providing additional load support.

Another object of the present invention is to provide an elastomeric tire having a center arch shaped cavity where the thickness of the tire between the cavity surface the tire outer surface, under the tread, is constant and provides a uniform wall thickness that is selected to support a certain load when the cavity is at atmospheric pressure, and to provide a load transfer from the tire tread into the rim contacting ends of the arch shaped cavity, and which cavity has an arc of from one hundred seventy (170) to one hundred forty (140) degrees.

Still another object of the present invention is to provide an elastomeric tire where the arch shaped cavity is formed both within the tire, and as the tire casing exterior, under the tread, with both arches to have a uniform arc and with the thickness of the side walls and tire top area, under the tread, selected for a load as the tire will support when the cavity is at atmospheric pressure, and the arc of which arch shaped cavity is a uniform arch of from one hundred seventy (170) to one hundred forty (140) degrees around the arch from rim support points located on opposite sides of the tire that receive rim ends fitted thereto.

Still another object of the present invention is to provide an elastomeric tire that is preferably formed by molding methods, with each tire to have an inherent strength as governed by a selection of a uniform wall thickness between a center arch shaped cavity surface and the tire outer surface, under the tread, and with the tire arch supported at one hundred seventy (170) degrees and less between rim support points formed in the tire side walls that receive the rim ends to support a design load with the cavity at atmospheric pressure, and can, through a standard tire stem fitting, receive air passed under pressure into the arch shaped cavity, for increasing the effective tire load supporting ability.

Still another object of the present invention is to provide a tire whose inherent load supporting characteristics can be enhanced by an addition of plies, a belt or belts, mounted in the tire during its manufacture and can further include the mounting of beads around the opposite tire sides, at the tire inner circumference.

Still another object of the present invention is to provide a tire, with or without plies, belts or beads where the tire includes the arch shaped interior cavity that functions as a load bearing member for a selected tire thickness between the cavity surface and the tire outer surface, below the tread, providing a tire having an effective load bearing capability when at atmospheric pressure, and can be aired to function as a pneumatic tire, to increase the tire load bearing capacity.

The present invention is in a unique elastomer tire that is formed by molding methods from natural or synthetic rubber, urethane, or the like, preferably in a spin casting process, or processes, like those set out in U.S. Pat. Nos. 4,855,096; 4,943,323; 5,906,836, and 6,165,397, that the present inventor is a joint inventor of, and improvements thereto. Manufacture of the tire of the invention, as by such molding process or processes, may include a continuous bladder that is positioned in the tire mold that the elastomeric material is injected into, with the bladder forming the arch shaped cavity centered under the tread. Where, after curing, the tire containing the bladder is first removed from the mold, followed by a removal of the bladder from the tire. If the tire is formed to be open across its web area, as a transport tire where the tire side walls each terminate in an end or a bead end section that are each to be supported between rim inner and outer upright walls, the bladder can be pulled directly out from inside the tire. Alternatively, the mold can be formed with an interior mandrel or receive a core fitted therein containing belts, plies and beads wherearound the tire is cast. Both the bladder, mandrel or core of belts, plies and beads, are for positioning in the center of the mold cavity to direct the flow of elastomeric material to travel freely therearound, forming a tire with an internal arch shaped cavity that is centered under the tire tread.

A proper tire arch-shaped cavity will have a uniform radius taken from a point of origin of the arch that vertically bisects the tire, with a maximum arc of the arch being one hundred seventy (170) degrees and a minimum arch of one hundred forty (140) degrees between rim points of engagement formed in the opposing tire sides whereat the rim ends are fitted. A tire with an arch of up to one hundred seventy (170) degrees and greater than one hundred forty (140) degrees will provide, with the tire at ambient pressure, a very stable side wall junction of the tire side wall to the rim ends, supporting the tire under a load with little tire flexure at its rim junctions.

The tire inner and outer surfaces around the arch, below the tread, are spaced a like distance apart, providing a uniform wall and tread thickness of tire material. For the tire to support a design load, at an ambient air pressure, the cavity surface is formed to have a uniform arc of from one hundred seventy (170) to at least one hundred forty (140) degrees as taken from points on the opposing tire side walls whereto rim ends are fitted, and with the outer surface of the tire, below the tread, exactly following the arc of the inner cavity. The distance between the cavity inner and tire outer surfaces, or wall thickness, is the same as measured around the tire, and this thickness, along with a selection of an appropriate elastomeric chemical combination, provides for supporting a particular load as the tire is designed to carry, and which wall thickness is increased as the load increases. So arranged, the cavity arch and the selected tire casing thickness to a like outer arch, under the tread, provides a unique load bearing structural support with the cavity at atmospheric pressure that will support a design load. Additionally, the tire interior arch shaped cavity can be aired to an appropriate pressure to further increase its load carrying capability, and with, to further increase the inherent load bearing capability of the un-inflated tire, such as a heavy duty transport tire, the tire side walls, across and under the tread, can be reinforced by an inclusion of plies and/or with one or more belts included under the tread. For mounting the tire onto a rim, the tire preferably includes beads cast within the tire.

Unique to the invention, its interior cavity is formed as a load bearing arch of at least one hundred forty (140) and no more than one hundred seventy (170) degrees or arc that will provide an inherent load support strength for a thickness between the arch shaped cavity wall and the tire outer wall, under the tread. The tire of the invention, with the tire arch shaped cavity pressurized to atmospheric pressure only, will exhibit a load bearing capacity in relation to its wall thickness for supporting a wide range of tire loads. The tire of the invention will not experience a flat, and, additionally, the arch shaped tire cavity of the invention can be pressurized to more than atmospheric pressure to increase its inherent load-bearing character.

Still other benefits and advantages of the invention will become apparent to those skilled in the art to which it pertains upon a reading and understanding of the following detailed specification.

### DESCRIPTION OF THE DRAWINGS

The invention may take physical form in certain parts and arrangement of parts, and preferred embodiments of which will be described in detail in this specification and illustrated in the accompanying drawings which form a part hereof:

FIG. 1A shows a cross section perspective view of an automotive tire of the invention that has an internal arch-shaped center cavity that is shown formed with an arc of one hundred seventy (170) degrees, and with the tire shown as open across a lower portion for mounting onto a rim as a pneumatic tubeless tire, and showing the tire as having a first tread embodiment;

FIG. 1B is a view like that of FIG. 1A only showing the tire as having an arch of one hundred forty (140) degrees;

FIG. 2A shows an automotive tire like that of FIG. 1B that is under a load, as illustrated by arrows A;

FIG. 2B shows a tire like that shown FIG. 2A only illustrating the load with arrows B;

FIG. 2C shows a tire like those shown in FIGS. 2A and 2B, but illustrates an applied load with arrows C;

FIG. 2D shows a tire like those shown in FIGS. 2A, 2B and 2C, but illustrates the applied load with arrows D;

FIG. 2E shows a graph of tire wall thickness T1 through T4 against the applied load, to summarize the relationships of FIGS. 2A though 2D;

FIG. 3 shows a side elevation view of a section of the tire of FIG. 1B that has a centered internal arch shaped cavity that is formed with an arc of one hundred forty (140) degrees, is mounted onto a rim, with the tire shown as being formed to resemble a pneumatic tubeless tire, and is open across a bottom area to fit in a rim that includes supports to maintain the tire side wall ends inner and outer surfaces at the ends of the one hundred forty (140) degree arc.

FIG. 4 shows a tire that is similar to the tire of FIGS. 1A and 1B except as to its rim mounting, is shown mounted onto a rim, and with the tire shown as including beads maintained within the tire ends wherefrom a continuous section extends between the cavity wall and the tire outer surface, functioning as tire plies and a belt; and

FIG. 5 shows a side elevation view of the rim whereon the tire of FIG. 4 is mounted.

### DETAILED DESCRIPTION

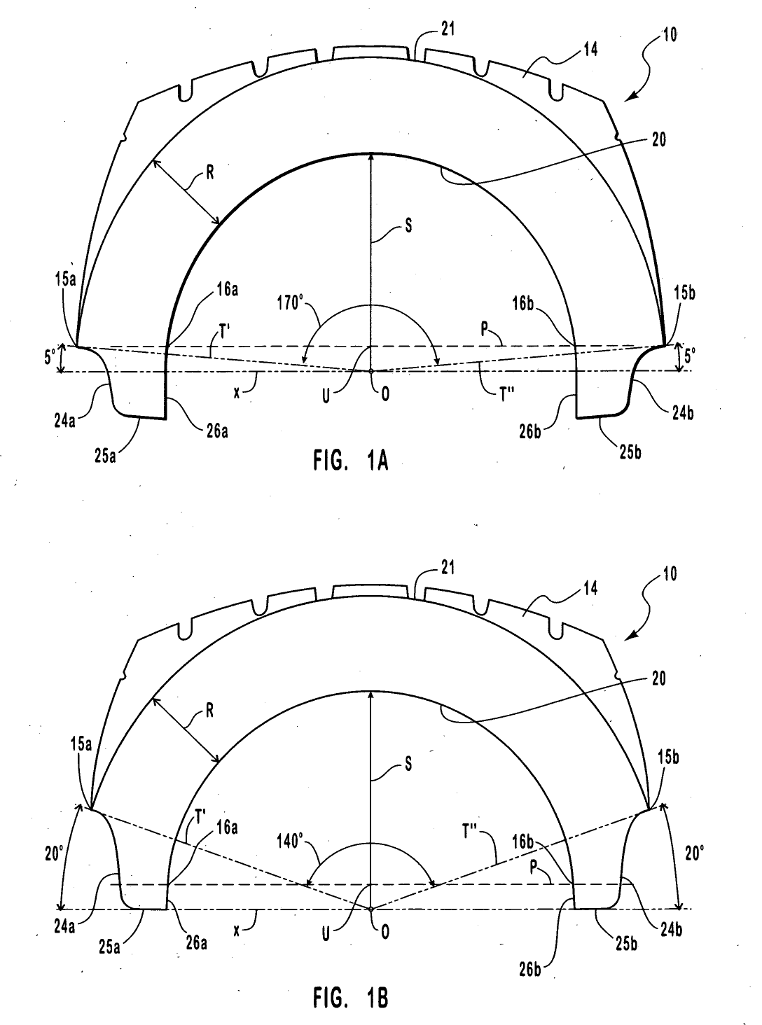

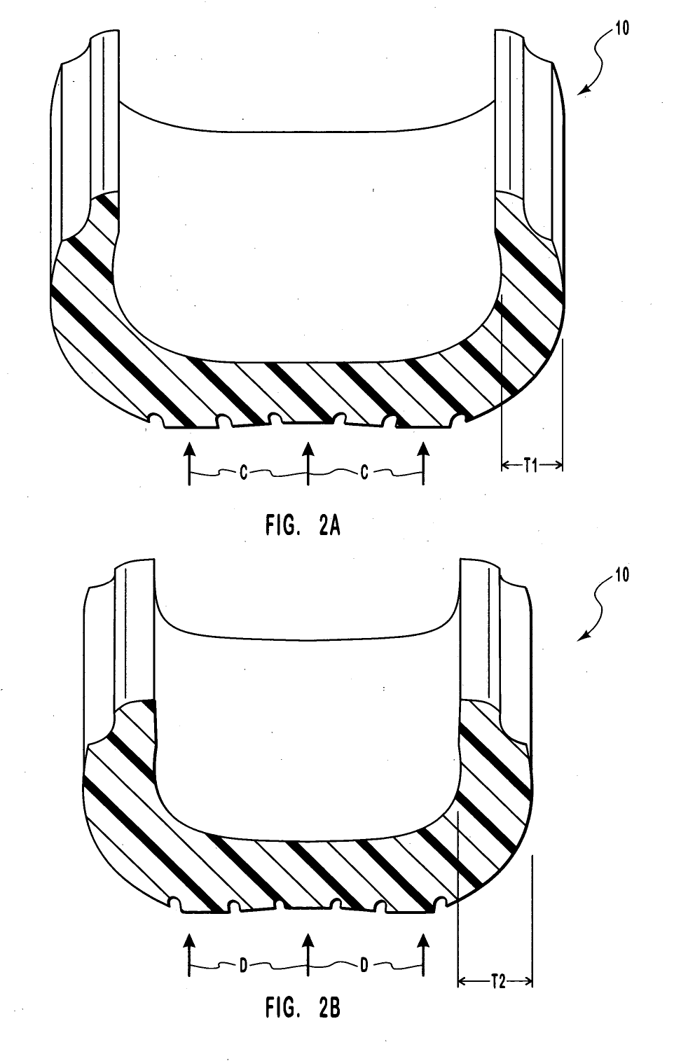

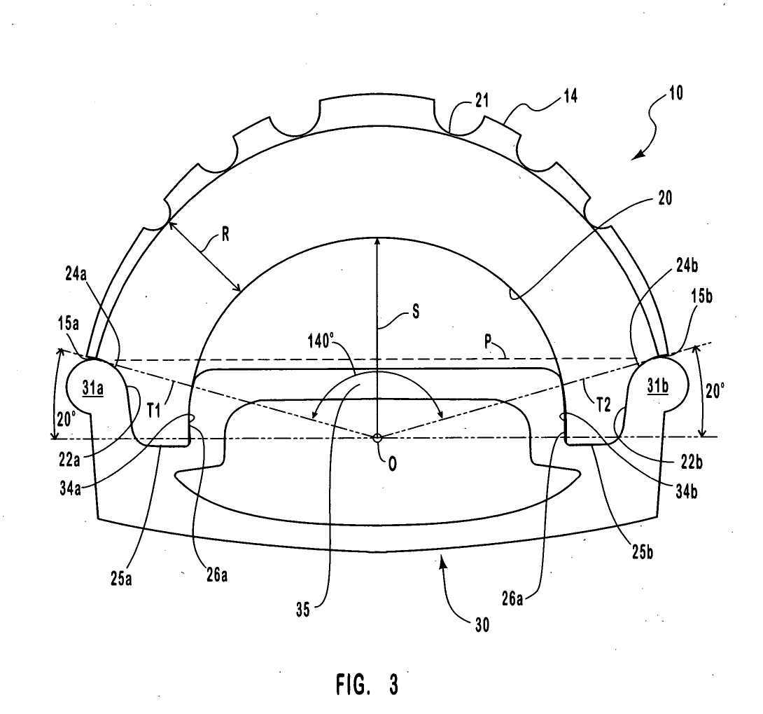

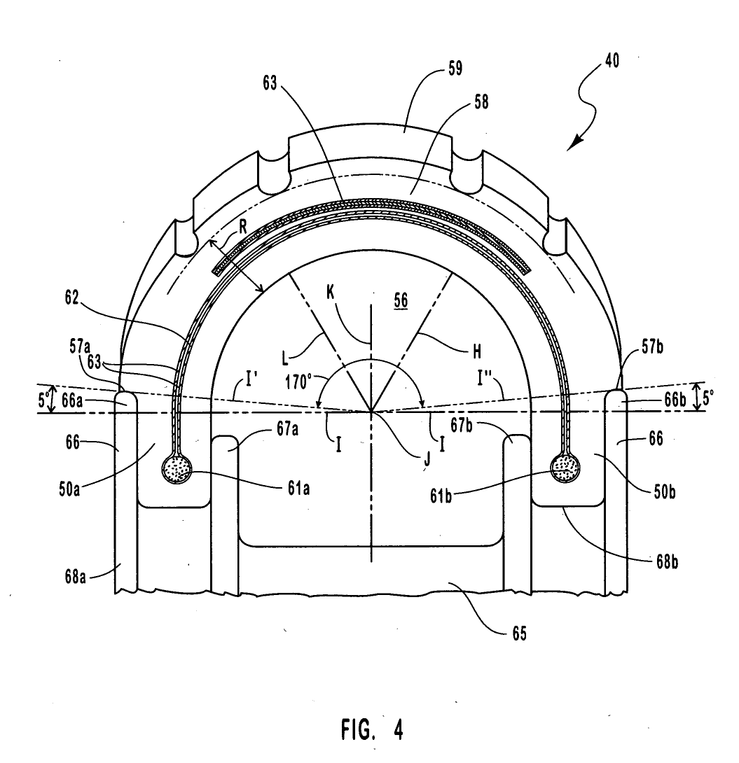

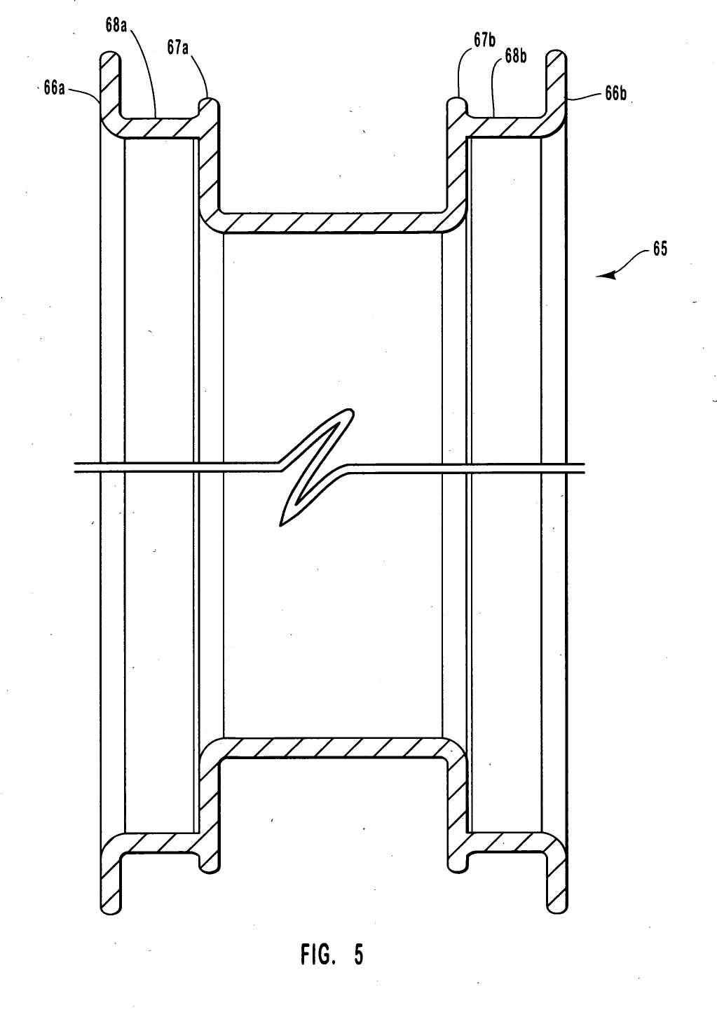

An automobile tire 10 of the invention is shown in FIGS. 1A, 1B and 3. An automobile tire is shown in FIG. 4 that is like the tire of FIGS. 1A, 1B and 3, but also includes internal beads and a combination of plies and belts, mounted within the tire and secured to a rim at its ends, between the beads. Which embodiments of automobile tires and their unique construction are discussed in detail herein below.

The tire 10, and the tire embodiment 40 of FIG. 5 of the invention, each includes a casing or body that is preferably formed from an elastomeric material, such as a urethane material, preferably utilizing spin casting methods like those described in apparatus and method patents, U.S. Pat. Nos. 4,855,096; 4,943,323; 5,906,836 and 6,165,397, that the present inventor is a co-inventor of. Though, it should be understood, the invention could be manufactured from other elastomeric materials, such as natural or synthetic rubber, and by other methods and apparatus from that shown in the above set out U.S. patents, to include: molding where a urethane or rubber material, in a liquid form, is poured into a mold; or by a pressure molding of a rubber material where the material is squeezed, as in a mold, into a tire shape; or a like process or procedure can be employed to form the tire or tires of the invention, within the scope of this disclosure. It should therefore be understood that the invention resides in the unique arch-shaped interior cavity and with a selected uniform wall thickness around the interior arch and the arch-shaped outer surface, below a tire tread, with the tire for mounting in a rim, with the selection of tire wall thickness, providing for a designed load-bearing or structural strength. The arch shaped cavity, in conjunction with the tire side walls mountings in a rim, provides for the tire being under a compressive load at all times, with the load forces directed around the arch and into the tire mounting points to the rim. The tire load-bearing ability is inherent in the structure of the arch-shaped cavity and is present even when side loads are exerted against the tire. So arranged, the tire of the invention will exhibit a load-bearing ability, even when the tire interior is at atmospheric pressure, for supporting a design load. Which tire load-bearing strength can be increased by adding air to the cavity, as through a valve stem, or the like.

Heretofore, tires formed with cavities have not utilized an arch shaped interior where the arch is duplicated as the tire outer surface under the tread as a load supporting member, with that load bearing ability directly related to tire thickness, as does the invention. As shown in FIGS. 1A and 1B, the invention is in a tire having an arch shaped interior cavity that is formed to have a uniform curve of one hundred seventy (170) to one hundred forty (140) degrees of arc. Which arc, as shown in FIGS. 1A and 1B, is from tire rim contact point 15a on one tire side, shown herein as a left side of the tire 10, to a tire rim contact point 15b, shown herein located on the right side of the tire 10. Which tire contact points 15a and 15b are shown as the points of contact of a rim 30 hook ends 31a and 31b, in FIG. 3. Shown in FIGS. 1A, 1B and 3, show a horizontal broken line P is passed through the tire contact points 15a and 15b that contact, as shown in FIG. 3, tops of rim hook ends 31a and 31b of rim 30, intersecting a vertical line S that bisects the tire 10, providing a point of intersection, shown as U. Shown in FIG. 1A, from intersection point U with line S, a point O is located along the line S, below the intersection point U, wherefrom an arc of one hundred seventy (170) degrees is shown formed between the tire contact points 15a and 15b. In FIG. 1B, from the point O, below, intersection point U, an arc of one hundred forty (140) degrees is shown as formed between the tire contact points 15a and 15b, illustrating the range of angles of arc of tire 10 and from a maximum of one hundred seventy (170) to a minimum of one hundred (140) degrees. The location of point O is determined by the arcs of the tire 10 inner and outer surfaces 20 and 21, respectively, that are identical and are between one hundred seventy (170) degrees and one hundred forty (140) degrees, respectively, as shown in FIGS. 1A and 1B, respectively. Which arcs are taken, for the outside tire surface 21, below the tire tread 14, between the contact points 15a and 15b and the tops of rim hook ends 31a and 31b, as shown in FIG. 3, and between points 16a and 16b for the inside tire surface 20. Which points 16a and 16b are shown in FIGS. 1A and 1B as the intersections of the horizontal broken line P with the tire 10 inner surface 20. FIG. 1A shows the tire 10 inner and outer surfaces 20 and 21 as each having an arc of one hundred seventy degrees (170), and FIG. 1B shows the tire 10 inner and outer surfaces 20 and 21 as each having an arc of one hundred forty (140) degrees, illustrating that the range on arcs of tire 10 is from one hundred seventy (170) to one hundred forth (140) degrees.

Shown also in FIGS. 1A and 1B, the tire 10 has a uniform thickness R from its tire contact points 15a and 15b and 16a and 16b between the inner and outer surfaces 20 and 21. Which thickness R is selected for a design load as the tire 10 will carry, as discussed later therein. As an illustration, from the selected point O spaced along the line S, an arc from which points O and O′, taken from horizontal line to lines T′ and T″, will form an arc of between five (5) degrees and twenty (20) degrees, as shown in FIGS. 1A and 1B, illustrating that which angles added to the arc of the tire 10 inner and outer surfaces 20 and 21, from tire contact points 15a and 15b and points 16a and 16b, are an arc of one hundred eighty degrees.

Shown in FIGS. 1A and 1B, the tire 10 outer side wall, below the tire contact points 15a and 15b, is curved inwardly at curves 24a and 24b that terminate in essentially flat ends 25a and 25b. Which curves 24a and 24b and essentially flat ends 25a and 25b and identical and are to receive a rim web adjacent to the hook ends, as shown in FIG. 3 and described hereinbelow. In practice it has been found that, for an arc of one hundred seventy (170) degrees and not less than one hundred forty (140) degrees, the junction of which curved rim mounting surfaces 24a and 24b will transfer a load directed against the tire 10 tread 14 as compressive forces, even when that load becomes a partial side load, that could create a shearing force. At an arc of greater than one hundred seventy (170) degrees and less than one hundred forty (140) degrees, however, shearing forces create flexure of the tire side wall, causing a heat build-up and potential damage to the tire over time.

Shown in FIG. 3, and as further set out below, the tire 10 of FIG. 1B is mounted onto a rim 30, whose hook ends 31a and 31b fit into and support the tire 10 recessed area 24a and 24b formed in the opposite tire side walls. So arranged, the tire of the invention will continue to exhibit essentially only compressive loading, even under side loads, while still exhibiting a pneumatic tire like performance, providing the arc or the inner and outer arches are alike and are not less than one hundred forty (140) degrees and not greater than one hundred seventy (170) degrees. Which inner and outer arches 20 and 21 are equidistant from one another, as illustrated as arrow R, as shown in FIGS. 1A and 1B, and are centered on a vertical line S that divides the tire at its intersection with a horizontal line P.

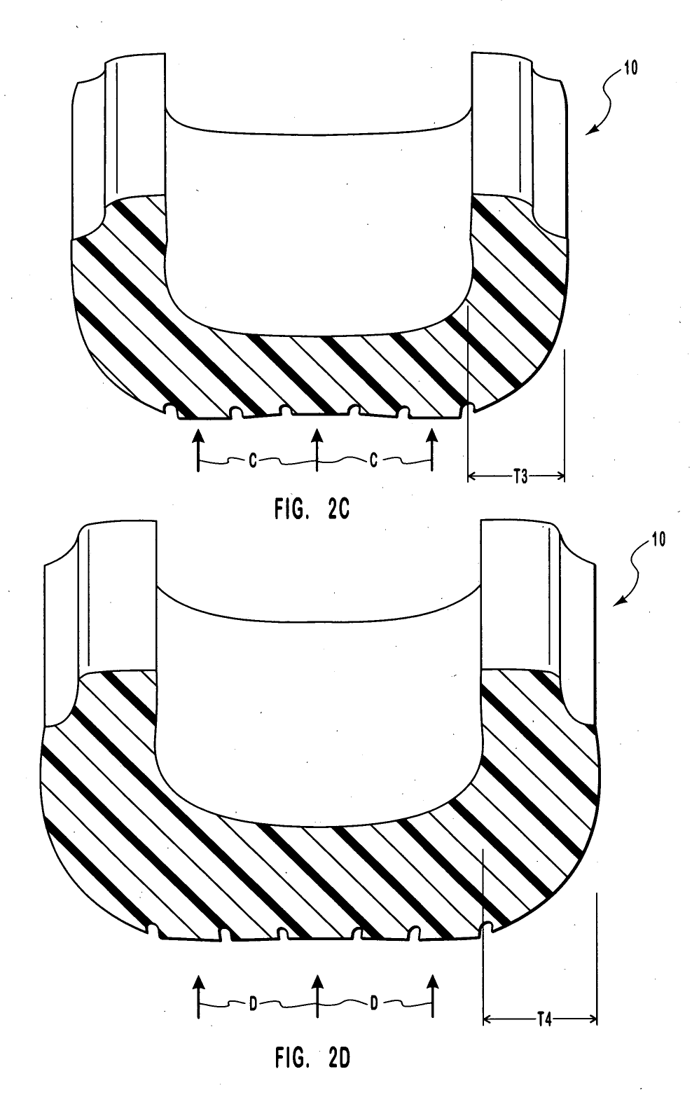

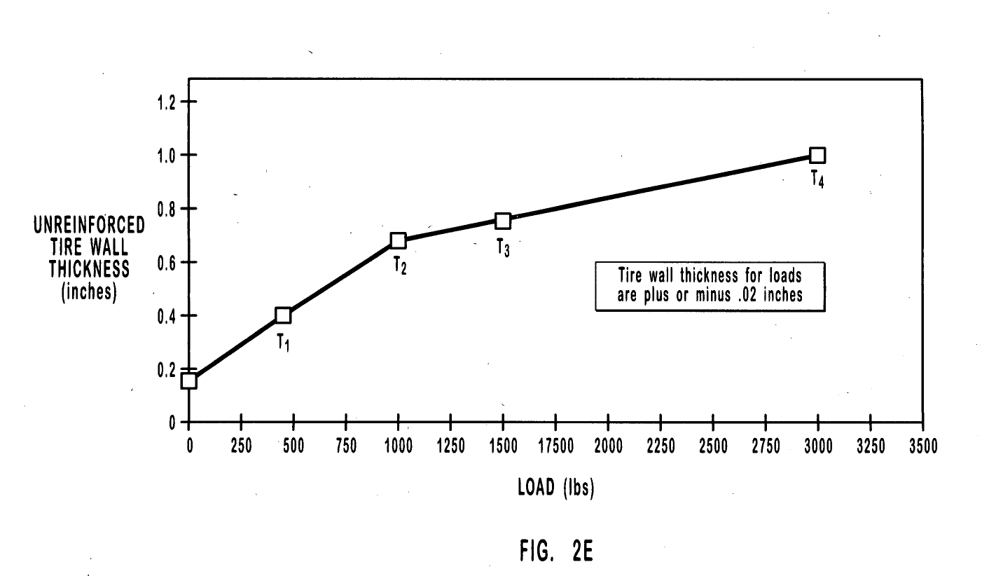

The rim 30 hook ends 31a and 31b top surfaces that are in contact with the tire between the tire contact points 15a and 15 and points 16a and 16b of the tire 10 of FIGS. 1A, 1B and 3 of the invention, as discussed above, are shown here to illustrate the tire 10 support points to the rim for the tire having an inner and outer arc of from one hundred seventy (170) to one hundred forty (140) degrees or arc, will transmit varying loads, as illustrated in 2A through 2D, through the tire into the rim. Which loads for different tire thicknesses R are summarized in the graph of FIG. 2E. Which graph of FIG. 2E shows that relationship of tire thickness, shown as R, between the identical inner and outer arches 20 and 21 directly relates to the load as the tire 10 can carry, even at ambient pressure conditions within the tire.

As set out above, the arc for the centered arch-shaped cavity, as shown in FIGS. 1A, 1B and 3 utilizes an appropriate length of a first radius to the inner cavity wall 20 illustrated from O, depending upon the arc as is selected from one hundred seventy (170) to one hundred forty (140) degrees, and a second radius from the same point O to tire 10 outer surface 21, below the tread 14, providing a uniform wall thickness between the tire 10 inner cavity and tire outer surfaces, under the tread. Which thickness R, as set out above, is selected, as shown in FIGS. 2A, 2B, 2C and 2D, to provide a desired or design load-bearing capacity when the inner cavity is at atmospheric pressure. The tires 10, as well as the tire 40 discussed below with respect to FIG. 4, it should be understood, are each preferably formed from an elastomeric material that is preferably a combination of an isocyanate and a polyol as a chain extender that are sprayed together in the spin casing process to form the tires 10 and 40.

FIG. 2A shows, with arrows M, a force directed into tire 10, that is the force shown also in a graph of FIG. 2E, and illustrates an anticipated tire load of four hundred (400) pounds. Which load, to be supported, requires a tire wall thickness, T1, of at least 0.40 inches, plus or minus 0.02 inches. FIG. 2B shows, with arrows N, a force directed into tire 10, that is the force shown also in the graph of FIG. 2E, and illustrates an anticipated tire load of one thousand (1000) pounds. Which load, to be supported, requires a tire wall, T2, of at least 0.70 inches, plus or minus 0.02 inches. FIG. 2C shows, with arrows O, a force directed into tire 10, that is the force shown also in the graph of FIG. 2E, and illustrates an anticipated tire load of fifteen hundred (1500) pounds. Which load, to be supported, requires a tire wall thickness, T3, of at least 0.75 inches, plus or minus 0.02 inches. FIG. 2D shows, with arrows P, a force directed into tire 10, that is the force shown also in the graph 2E, and illustrates an anticipated tire load of three thousand (3000) pounds. Which load, to be supported, requires a tire wall thickness, T4, of at least 1.00 inches.

The graph of FIG. 2E summarizes the load to tire wall thickness relationships, as set out in FIGS. 2A through 2D, where each tire wall thickness is set out, plus or minus point zero two (0.02) inches above a four hundred (400) pound load, and shows a minimum thickness of approximately point one six (0.16) inches as an intercept with the wall thickness axis, and with a straight line extending therefrom to a thickness T1 of point four (0.4) inches, for a load of four (4) hundred pounds, as shown in FIG. 2A. The graph shows a straight line relationship with a uniform slope between the loads of from a minimum tire thickness to four hundred pounds, as shown in FIG. 2E. From which tire thickness T1 to T4 the slope is also approximately a straight line relationship, but is at a lesser slope. FIG. 2E thereby demonstrates that, from a minimum wall thickness R, the tire side wall, for a tire at ambient pressure only, increases proportionally to increases in load. Which thickness increase, is at a greater slope between the intercept with the tire thickness axis and T1, and is lesser between T1 and T4, indicating that the increases as are necessary to support a design load of from approximately four hundred (400) pounds to three thousand (3000) pounds are less dramatic than the thickness changes as are needed to support a load of from zero to four hundred (400) pounds. The FIGS. 2a through 2D, and the graph of FIG. 2E, thereby demonstrate the direct relationship between tire wall thickness and a load the tire can carry or support when the arch shaped cavity is at approximately atmospheric pressure. The tire wall thickness, as discussed above, is defined as a uniform wall thickness from the tire points of engagement or support points 15a and 15b around the tire, under the tire tread, and two variations of tire treads, as are appropriate for use with the automobile tire of the invention, are shown in FIGS. 1A, 1B and 3, as treads 14, as they are functionally alike. As set out above, the uniform tire wall thickness varies with load for an arc of not less than one hundred forty (140) degrees to not more than one hundred seventy (170) degrees, to provide the required support strength to support loads like those set out in FIGS. 2A through 2D above.

FIG. 3 shows an automobile tire 10 embodiment of the invention that is the tire of FIG. 1B and has an arch shaped cavity with an arc of one hundred forty (140) degrees. While the tire 10 is preferably manufactured from an elastomeric material, preferably a urethane, by spin casting methods, it may also be formed from a natural or synthetic rubber, or the like, by liquid or pressure molding or by other methods, within the scope of this disclosure. In which preferred spin casting method of manufacture, a mold is formed to cast tire 10 that is open between its lower or web ends 25a and 25b to fit in rim 30. Shown in FIG. 3, the tire 10 curved side wall ends 24a and 24b are located below the side wall rim support points 15a and 15b, respectively, and with the tire lower ends ends 24a and 24b to fit against a rim web, between outer support hook end sides 22a and 22b and vertical inner sides 26a and 26b of rim 30.

The tire 10, of FIG. 3, as described above, is formed with the arch shaped inner cavity below inner surface 20 that has an arc of one hundred forty (140) degrees, illustrating a lower limit of a range of acceptable arcs of an arch-shaped cavity of the tire of the invention. So formed, the inner arch-shape cavity 20 arc and the arc of the tire outer surface 21, below the tire tread 14, are alike, and the distance therebetween, or thickness R, is the same. The distance R between the inner cavity surface 20 and the outer surface 21, under the tread, is the same, and is carefully selected, as shown in FIGS. 2A through 2E, for the anticipated load as the tire will carry. FIGS. 1A, 1B and 3 thereby illustrate that the arc of the arch-shaped cavity 10 can be from one hundred forty (140) up to and including one hundred seventy (170) degrees to maintain, in compression and without air above ambient pressure being present in the cavity, a design load. So arranged, the arch-shaped cavity of tire 10 alone provides a load-bearing structure that is essentially the equivalent of the support provided by a like pneumatic tire that is pressurized appropriately. In practice, a tire 10 has an effective load-bearing character that is the equivalent of a conventional pneumatic tire pressurized to from thirty-five (35) to forty (40) psi. Further, the effective pressurization of the tire 10 can be increased by pressurizing the interior of the arch-shaped cavity, as discussed above. The thickness of the tire 10 tread 14 does not, in practice, affect the load-bearing capabilities of the tire and therefore may be any appropriate thickness to provide the desired road gripping, traction, wear and stability characteristics.

The tire 10 of FIG. 3, as set out above, is formed to resemble a conventional tube type or tubeless pneumatic tire for mounting on rim 30. In which mounting the tire 10 side wall curved end portions 24a and 24b are fitted into the rim 30, with the rim hook ends 31a and 31b facing one another such that the rim hook ends opposing surfaces 22a and 22b fit, respectively, into the tire side wall curved mounting grooves 24a and 24b. So arranged, the tire 10 side wall ends interior surfaces 26a and 26b are supported against ends 34a and 34b of a rim center platform 35. As needed, to add additional mounting support, as shown in FIG. 4, beads 61a and 61b, that are preferably hoops and are formed of a material, such as steel, carbon fibers, or the like, to be inelastic, can be included in a tire, around and within the ends of the tire side walls to provide for locking of the tire side wall ends in the rim. While a tire like tire 10 without beads has, in practice, functioned as a light automobile tire, it is preferred, to insure a secure tire mounting onto a rim, that beads are used. For some light duty tire application, such as for a wheelbarrow, golf cart or motor scooter tire, or the like, however, beads may not be required. In practice, such a light duty tire without beads that incorporated the arch-shaped cavity maintained at ambient pressure was found to safely support a load of seven hundred (700) pounds, and which tire was aired to a pressure of approximately six (6) pounds safely supported a load of one thousand (1000) pounds, illustrating the versatility of the tire 10 of the invention.

A tire 40 of FIG. 4 is like the tire 10 in its shape, construction and manufacture and has essentially the same design. Tire 40 is also preferably formed from an elastomeric material, preferably a urethane elastomer, but may be formed from natural or synthetic rubber, or the like, by spin casting, molding or other methods, producing a tire 40 that is open between its side wall ends 50a and 50b and incorporates an arch shaped cavity 56. The arc of which cavity 56 is shown to have an arc of one hundred seventy (170) but, like the tire 10, may have an arc of from one hundred forty (140), the Figs. Illustrating that the tire outer surface and cavity have like arcs that can be from one hundred forty (140) to one hundred seventy (170) degrees of arc, within the scope of this disclosure, between tire contact points 57a and 57b with the tops of rim 65 side walls 66 top ends 66a and 66b. Which arc is illustrated as a radius R that is an arc, from one tire rim support point 57a, around the tire, to a tire rim support point 57b formed in the tire sides walls, proximate to the tire ends, which arc is illustrated a radius turned from a point J that is the intersection of a horizontal line I laid across the tire, below the tire side walls rim support points with a rim 65 side walls 66 top ends 66a and 66b, and vertical line K that bisects the tire 40. The tire outer arch is illustrated as taken also from point J by a longer radius M. In practice, the inside and outside arcs must match, with the distance R, like the distance R shown in FIGS. 1A, 1B and 3, being the wall thickness between the inner cavity arch and the outer arch, under the tire tread 59, and is a like distance around the tire to the tire rim support points or rim mounting grooves 57a and 57b, and across the tire top portion 58, below the tread 59. Which distance R, like the distance, R for tire 10, is selected for the tire-anticipated load. The tire arch-shaped cavity wall end portions 50a and 50b are narrowed at the tire side rim support points or mounting grooves 57a and 57b into essentially parallel sides that terminate at ends 68a and 68b and are fitted between rim outer and inner walls 66 and 67a and 67b, respectively. The tire 40 side wall end portions 50a and 50b, like the side wall ends of tire 10, are for fitting in, and are supported on the rim sides 66 and 67a and 67b, respectively.

The tire 40, as shown in FIG. 4, is mounted to rim, like rim 65 shown in FIG. 5, as described above with respect to FIG. 4, and has, in practice, been produced as a high duty tire that is suitable for use on a light automobile. Like tire 10, tire 40 is preferably manufactured from urethane elastomer, natural or synthetic rubber, or the like, utilizing spin casting or liquid or pressure molding methods to have a wall thickness across the cavity arch, under the tire tread, that is selected to support a design load, as set out above with respect to the discussion of FIGS. 2A through 2E. So arranged, with the tire arch-shaped cavity at atmospheric pressure, dependant upon the selected wall thickness the tire 40, like tire 10, will support a design load, that can be further enhanced by the inclusion of beads 61a and 61b, and may be reinforced with a ply or plies 62. Which ply or plies ends, as shown, can wrap around the beads 61a and 61b, and extend around the cavity arch, encapsulated between the arch shaped cavity wall and the tire outer wall. Further, a belt 63, as shown, or belts 63 can be fitted around the tire, above the plies, with the combination of plies and belts functioning like belts and plies of a pneumatic tire. So arranged, the tire 40 with beads 61a and 61b, the continuous ply or plies 62, and belt or belts 63, is capable of supporting higher loads and/or which beads, plies and belt or belts are included for safety reasons. The ply or plies 62 and belt or belts 63 are preferably formed as flat meshes from fiber glass, carbon or graphite fibers, steel, or the like materials, and are installed in the tire 40 during the tire casting or molding process. At least one of which plies, as shown in FIG. 4, extends to the beads 61a and 61b, that are continuous hoops that are preferably formed from a high tensile strength material, and are installed at the end portions of the tire side walls. The inclusion of beads 61a and 61b along with ply or plies 62 and belt 63 provides structural strength to the tire that is additional to the structural strength provides by the selection of tire thickness R between the arch-shaped inner cavity wall and the tire outer surface, under the tread, for a design load.

The tires 10 and 40, to carry an appropriate design load, are formed with the arch shaped cavity and to have a wall thickness as is appropriate, to safely handle such design load. Further, each tire 10 and 40, can include a valve stem, fitted thereto, or the like, for injecting air under pressure into the tire arch-shaped cavity, for increasing the load carrying capability of the tire.

Preferred embodiments of the air no air elastomeric tire of the invention have been shown and described above. It will, however, be apparent to one knowledgeable or skilled in the art that the above described embodiments may incorporate changes and modifications without departing from the general scope of this invention. Which invention therefore is intended to include all such modifications and alterations in so far as they come within the scope of the appended claims and/or a reasonable equivalence thereof.

I claim:

1. An elastomeric tire comprising, a tire casing formed by casting methods from an elastomeric material to have a continuous arch shaped interior cavity with the arc of said interior arch shaped cavity centered between end portions of said tire casing and including a tire casing outer portion that has a same arc as the arc of said interior arch shaped cavity, and said interior arch shaped cavity and said tire casing outer portion have a like uniform arc of from one hundred forty (140) to one hundred seventy (170) degrees from one tire rim mounting contact point on one said tire side, around the tire surface under the tread to another tire rim mounting contact point of the other said tire side, where the arc is taken from a point along a vertical center line that bisects the tire casing that is selected to produce the selected are of from one hundred forty (140) degrees to one hundred seventy degrees between said tire rim mounting contact points, and said tire casing has a uniform thickness across said arches that is selected for a particular anticipated load as said tire will support with said inner arch shaped cavity at atmospheric pressure; a continuous tread portion secured around an annular surface to said tire casing outer portion; means for mounting said end portions of side walls of said tire casing to a rim; and a valve stem means installed through said rim and into said arch shaped cavity for passing air under pressure therein.

2. The elastomeric tire as recited in claim 1, wherein the tire casing side walls each include an identical mounting groove or slot whose top end is the tire rim mounting contact point that are each formed around a tire side wall end portion, with each said groove or slot for fitting to an end portion or slot of a rim side wall, for mounting said tire casing onto said rim.

3. The elastomeric tire as recited in claim 1, where the tire casing is open across the tire casing side walls, and the rim is provided with outer and inner upstanding side walls or hook ends for receiving and supporting lower end portions of said tire rim mounting contact points and tire side wall end portions; and the rim is fitted with a valve stem passed therethrough and into the arch shaped cavity for passing air under pressure therein.

4. The elastomeric tire as recited in claim 1, wherein the thickness of the material between the inner arch shaped cavity and casing outer portion arch, under the continuous tread portion annular surface, is selected to support, when said inner arch shaped cavity is at atmospheric pressure, an anticipate design load, with said thickness of material being less for supporting a light load than for supporting a heavier load, and which said thickness of material increases in proportion to increases in anticipated load.

5. The elastomeric tire as recited in claim 4, further including a pair of like beads that are each fitted and cast within the lower portions of the tire casing side walls.

6. The elastomeric tire as recited in claim 5, further including at least a first ply formed from a mesh material and is installed in the tire forming process to encircle the tire top portion, below the tire tread and within the tire side walls, with ends of said ply extending to said tire side walls lower portions.

7. The elastomeric tire as recited in claim 6, wherein the mesh material is a mesh of fiber glass, a weave of graphite or carbon fibers, steel, or other appropriate material, formed into a flexible mesh material to extend around the tire casing.

8. The elastomeric tire as recited in claim 6, wherein the pair of like beads are each identical hoops formed from a material that is inelastic and has a high tensile strength, with each said hoop fitted in each of the lower portions of the tire side walls, and each said bead is in contact with an edge of the first ply.

9. The elastomeric tire as recited in claim 8, further including a second ply formed of a material like that of the first ply and installed in the tire forming process to pass over the tire top portion, extending into the tire side walls lower portions and engage the beads.

10. The elastomeric tire as recited in claim 9, wherein the ends of each of said first and second plies are fitted around each bead

11. The elastomeric tire as recited in claim 1, wherein the tire casing is formed from a elastomer by molding methods.

12. The elastomeric tire as recited in claim 11, wherein the tire casing is formed by spin casting methods.

13. The elastomeric tire as recited in claim 1, wherein the tire casing is formed form natural or synthetic rubber.

14. The elastomeric tire as recited in claim 14, wherein the tire casing is formed from an isocyanate and polyol as a chain extender that are combined together as sprays directed into a spin casting apparatus wherein the tire is formed.
